(19) United States
(12) Patent Application Publication
(10) Pub. No.: US 2013/0342592 A1
(43) Pub. Date: Dec. 26, 2013

(54) INKJET PRINTER FOR PRINTING ON A THREE-DIMENSIONAL OBJECT AND RELATED APPARATUS AND METHOD

(71) Applicant: Nicholas MERZ, San Francisco, CA (US)

(72) Inventor: Nicholas MERZ, San Francisco, CA (US)

(73) Assignee: Apple Inc., Cupertino, CA (US)

(21) Appl. No.: 13/541,029

(22) Filed: Jul. 3, 2012

Related U.S. Application Data
(60) Provisional application No. 61/664,677, filed on Jun. 26, 2012.

(51) Int. Cl. B41J 3/00

(52) U.S. Cl. 347/2

(57) ABSTRACT

An inkjet printer configured to print on a three-dimensional object is provided. The inkjet printer may include a print head that ejects a conductive ink. The inkjet printer may also include an assembly configured for adjusting a position of an object relative to the print head. The adjustment assembly may include a fixture configured to hold an object, such as a circuit board, that is to be printed on. The fixture may be configured to hold the object such that multiple surfaces thereof, which may be nonplanar, are exposed. A tilt adjustment mechanism may be coupled to the fixture and configured to adjust a tilt angle of the object. Further, a rotational adjustment mechanism may be coupled to the fixture and configured to adjust an angular position of the circuit board. Accordingly, the surfaces of the object may each be upwardly oriented such that the print head may print thereon.

### TECHNICAL FIELD

The present disclosure relates generally to inkjet printing on three-dimensional objects, and more particularly to methods, apparatuses, and printers for inkjet printing conductive ink on a circuit board defining nonparallel surfaces.

### BACKGROUND

Inkjet printers are well-known devices that are typically employed to dispense droplets of ink to form images on paper. However, inkjet printers may also be employed for other purposes. For example, inkjet printers may be employed to print conductive ink Conductive ink is a type of ink that includes conductive particles (e.g., powdered or flaked silver particles) therein. The conductive ink may be used to form circuits or perform related functions.

However, inkjet printers are typically configured to print on a single two-dimensional planar surface. Accordingly, existing embodiments of inkjet printers may have limited capabilities. Thus, while existing embodiments of inkjet printers may function well for their intended purposes, inkjet printers having enhanced functionality may be desirable.

### SUMMARY

Embodiments of the present disclosure relate to assemblies, methods, and inkjet printers configured for printing on three-dimensional objects. In this regard, three-dimensional objects present certain challenges that make it difficult to print thereon. Accordingly, the embodiments disclosed herein are configured to address such difficulties.

One embodiment of an inkjet printer may include a head assembly that includes a print head. The print head and/or the entire head assembly may be moveable in one or more directions. For example, the head assembly may be moveable in horizontal directions such that printing on a horizontal plane may be possible. Further, in some embodiments a vertical position of the print head may be adjustable. Accordingly, the inkjet printer may be able to maintain a constant separation distance from the object, even when it is three-dimensional.

However, ink is typically ejected under relatively low pressure such that the ink falls substantially vertically as a result of gravity. Thus, issues with respect to printing on vertical or undercut services of three-dimensional objects may exist. This issue may be of particular importance in the context of printing electromagnetic interference shields, which must be substantially continuous in order to be effective. In this regard, when the conductive ink is not evenly dispersed across the surfaces, a continuous structure may not be formed.

Accordingly, the inkjet printer may include an assembly configured for adjusting a position of the object relative to the print head. The adjustment assembly may include a fixture that holds the object such that the surfaces thereof that are to be printed on are exposed. Further, the adjustment assembly may include a tilt adjustment mechanism coupled to the fixture and configured to adjust a tilt angle of the object. The adjustment apparatus may additionally include a rotational adjustment mechanism configured to adjust an angular position of the circuit board. Accordingly, the tilt adjustment mechanism and the rotational adjustment mechanism may cooperatively function to upwardly orient each of the surfaces of the object such that they may be printed on.

In some embodiments the inkjet printer may include additional components. For example, the inkjet printer may include an insulation remover, which may be coupled to the print head in some embodiments. Accordingly, the insulation remover may remove a dielectric insulator from portions of the object prior to printing thereon, such that a grounded structure may be produced. The inkjet printer may additionally include a pretreatment apparatus coupled to the print head, or otherwise positioning the curing apparatus within the inkjet printer, that directs a pretreatment onto the object. The pretreatment may assist in adhering the conductive ink to the surfaces of the object. By locating the pretreatment apparatus proximate the print head, the surfaces of the object may be pretreated immediately prior to printing thereon. Further, the inkjet printer may include a curing apparatus that may emit light and/or heat to cure the ink. By coupling the curing apparatus to the print head, or otherwise positioning the curing apparatus within the inkjet printer, the ink may be cured immediately after being ejected onto the object, such that issues with respect to the ink running off the object prior to curing may be mitigated.

Other systems, methods, features and advantages of the disclosure will be or will become apparent to one with skill in the art upon examination of the following figures and detailed description. It is intended that all such additional systems, methods, features and advantages be included within this description, be within the scope of the disclosure, and be protected by the accompanying claims.

### BRIEF DESCRIPTION OF THE DRAWINGS

The included drawings are for illustrative purposes and serve only to provide examples of possible structures and arrangements for the disclosed inkjet printers, assemblies configured for adjusting a position of a three-dimensional object in a printer, and method for inkjet printing. These drawings in no way limit any changes in form and detail that may be made to the disclosure by one skilled in the art without departing from the spirit and scope of the disclosure.

FIG. 1 illustrates a circuit board including a component and a substrate that define a three-dimensional structure according to an example embodiment of the present disclosure;

FIG. 2 illustrates a perspective view of an inkjet printer including a print head and an assembly configured for adjusting a position of a three-dimensional object according to a first example embodiment of the present disclosure;

FIG. 3 illustrates a perspective view of the inkjet printer of FIG. 2 with the circuit board of FIG. 1 therein and first surfaces of the substrate and the component upwardly oriented according to embodiment of the present disclosure;

FIG. 4 illustrates a side view of the first embodiment of the inkjet printer in the configuration of FIG. 3;

FIG. 5 illustrates a side view of the first embodiment of the inkjet printer with a tilt angle of the circuit board adjusted such that a second surface of the component is upwardly oriented according to an example embodiment of the present disclosure;

FIG. 6 illustrates a perspective view of the first embodiment of the inkjet printer in the configuration of FIG. 5;

FIG. 7 illustrates a side of the first embodiment of the inkjet printer with the tilt angle and an angular position of the circuit board adjusted such that a third surface of the component is upwardly oriented according to an example embodiment of the present disclosure;

FIG. 8 illustrates a perspective view of the first embodiment of the inkjet printer in the configuration of FIG. 7;

FIG. 9 illustrates a perspective view of an inkjet printer further comprising pretreatment and curing apparatuses and an insulation remover according to a second example embodiment of the present disclosure; and

FIG. 10 illustrates a method for inkjet printing on a three-dimensional object according to an example embodiment of the present disclosure.

### DETAILED DESCRIPTION

Exemplary applications of apparatuses, assemblies, systems, and methods according to the present disclosure are described in this section. These examples are being provided solely to add context and aid in the understanding of the disclosure. It will thus be apparent to one skilled in the art that the present disclosure may be practiced without some or all of these specific details. In other instances, well known process steps have not been described in detail in order to avoid unnecessarily obscuring the present disclosure. Other applications are possible, such that the following examples should not be taken as limiting.

Inkjet printing may be employed to deposit conductive ink on a substrate. The conductive ink may comprise particles of conductive material (e.g., silver) suspended in a liquid. The particles of conductive material may be “cured” (e.g., via application of light and/or heat) to melt the particles to form a continuous strip of conductive material. In one embodiment, the continuous strip of conductive material may be employed to form a circuit. For purposes of brevity, all aspects of inkjet printing of conductive ink will not be discussed herein in detail.

In accordance with embodiments of the present application, various other structures and components may be formed by inkjet printing. In this regard, in one embodiment of the present disclosure an electromagnetic interference (“EMI”) shield may be printed with conductive ink EMI shields are configured to prevent interference with electrical components caused by electromagnetic induction or electromagnetic radiation emitted from an external source. Typically EMI shields are formed from solid metal “cans” that extend around the components being shielded. The cans are soldered to grounding pads such that they are grounded. Thus, the cans block external sources of radio emissions, etc. from interfering with the electronic components by blocking electromagnetic radiation from reaching the components.

Printing EMI shields presents certain challenges that may not be found in other contexts of inkjet printing. In this regard, EMI shields must be substantially continuous in order to effectively prevent electromagnetic interference. Accordingly, a conductive ink that is capable of forming a substantially continuous structure should be employed. By way of example, a suitable conductive ink is sold by CABOT of Boston, Mass. under the name CCI-310. Further, EMI shields should not define gaps with dimensions greater than one-quarter of the wavelength of the frequency of the electromagnetic radiation intended to be blocked. Accordingly, the EMI shield should be printed such that any gaps therein fall within these constraints.

Additionally, electronic components on a circuit board may be three-dimensional and define surfaces extending in different directions. Inkjet printers are typically configured to print on two-dimensional, planar, substrates. In this regard, the present application provides methods, apparatuses, and inkjet printers that may be employed to print on three-dimensional objects in order to produce EMI shields and other three-dimensional structures.

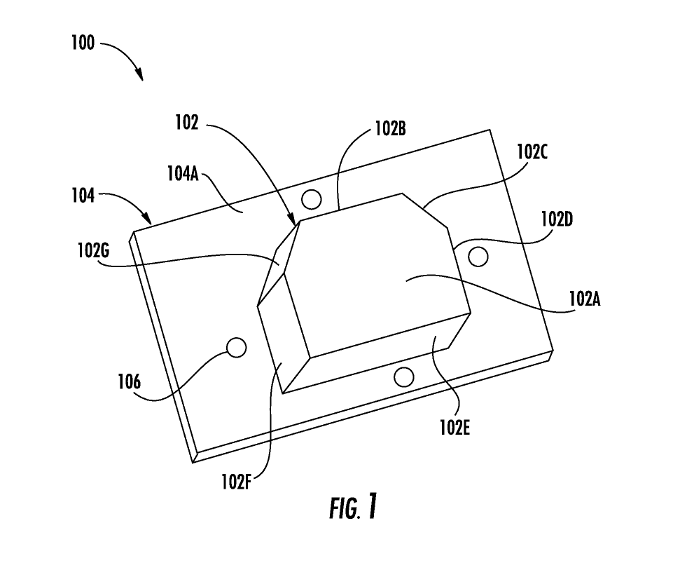

By way of example, FIG. 1 schematically illustrates a perspective view of a simplified embodiment of a circuit board 100. The circuit board 100 includes a component 102 (e.g., a processor, etc.) that is mounted to a substrate 104. A plurality of grounding pads 106 may be located around the component 102 such that an EMI shield for the component 102 may be connected to ground.

Prior to inkjet printing conductive ink onto the circuit board 100, the circuit board may be coated with a dielectric insulator material. For example, the circuit board 100 may be placed in a vacuum chamber and a dielectric insulator material such as Parylene may be vacuum deposited thereon. The layer of dielectric insulator material applied may be one to five microns thick in some embodiments. The dielectric insulator material may function to prevent conduction between the component 102 and the conductive ink printed thereon.

The grounding pads 106 may be masked-off prior to applying the dielectric insulator material. The mask may then be removed such that the ground pads are exposed. Thereby, the conductive ink may be printed on the grounding pads 106 to ground the EMI shield formed by the conductive ink. Alternatively, the dielectric insulator material may be placed on the grounding pads 106 (in addition to other portions of the circuit board 100), and then removed. For example, a laser may be employed to burn off the dielectric insulator material at the grounding pads 106, as discussed below. In embodiments of the circuit board 100 that include connectors, the connectors may also be masked off, or the dielectric insulator material may be removed from the connectors such that they are able to function after application of the dielectric insulator material. However, the dielectric material may not be removed until after printing of the conductive ink such that the ink is not deposited on the connectors.

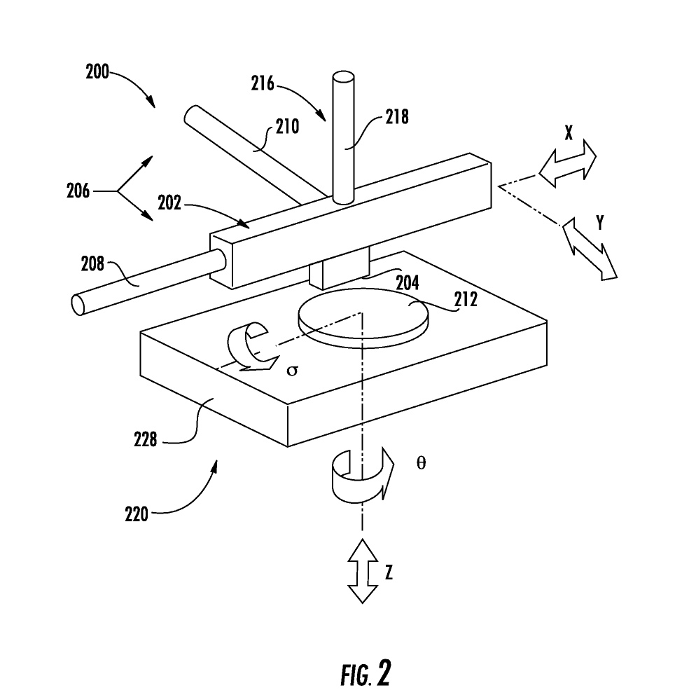

After the dielectric insulator material is deposited on the circuit board 100, conductive ink may be printed thereon to form an EMI shield (or other component or circuit, etc.). In this regard, FIG. 2 illustrates an inkjet printer 200. The inkjet printer 200 may include a head assembly 202 comprising a print head 204 configured to eject an ink, such as an embodiment of the above-described conductive ink. In one example embodiment the print head 204 may comprise the DIMATIX SPECTRA SE128, sold by FUJIFILM of Tokyo, Japan.

A horizontal adjustment mechanism 206 may be provided that is configured to adjust a horizontal position of the head assembly 202 and therefore any components thereof such as the print head 204. The horizontal adjustment mechanism 206 may be embodied in a number of different forms. However, in one embodiment the horizontal adjustment mechanism 206 may comprise first and second displaceable pistons 208, 210. The displaceable pistons 208, 210 may be respectively configured to adjust the position of the print head along first and second horizontal axes X, Y, which may be perpendicular to one another. However, since the horizontal adjustment mechanism 206 may comprise various other components configured to adjust the horizontal position of the base 202, the horizontal adjustment mechanism 206 is not illustrated in the remainder of the drawings.

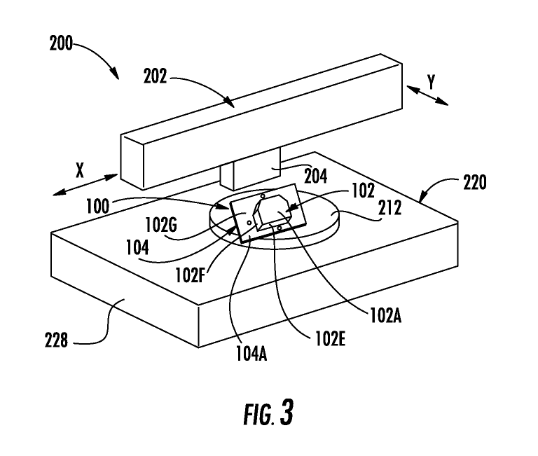

The inkjet printer 200 may further comprise a fixture 212 configured to hold objects such that one or more of the surfaces thereof are exposed (i.e., not covered). For example, FIG. 3 illustrates the inkjet printer 200 with the circuit board 100 of FIG. 1 held by the fixture 212. In order for the print head 204 to print on the circuit board 100, the fixture 212 may position the circuit board such that a surface thereof is upwardly oriented. The term upwardly oriented, as used herein, refers to orientation of a surface such that the surface defines a non-zero projected area in a horizontal plane, when viewed from above.

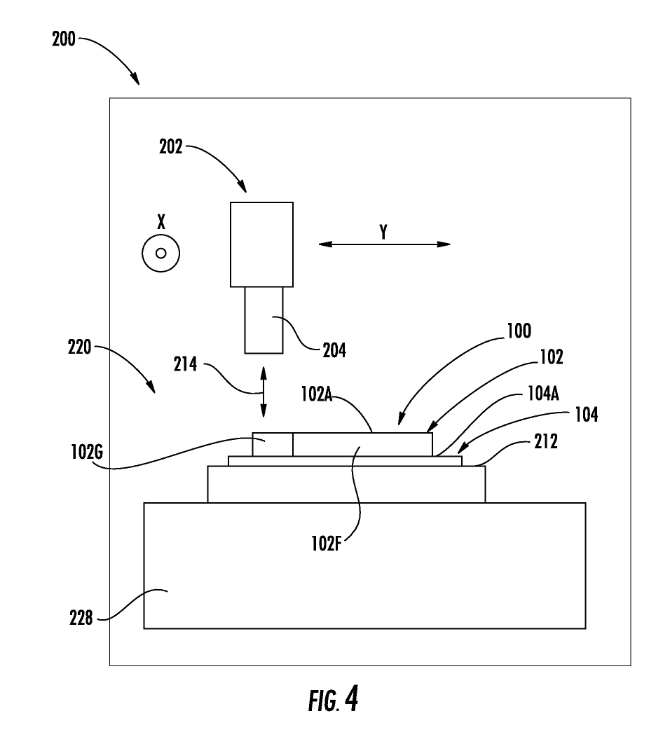

For example, FIG. 4 illustrates a side view of the inkjet printer 200 in the configuration of FIG. 3, wherein surfaces of the circuit board 100 are upwardly oriented. In particular, a first (major) surface 102A of the component 102 and a first (major) surface 104A of the substrate 104 are upwardly oriented. Accordingly, the print head 204 may eject conductive ink onto the first surface 102A of the component 102 and the first surface 104A of the substrate 104. In this regard, the inkjet printer 200 may be configured to print in a horizontal plane, as is typical of inkjet printers.

However, in order to deposit an equal density of droplets of the conductive ink on the first surface 102A of the component 102 and the first surface 104A of the substrate, which extend to different heights, it may be desirable to maintain a substantially constant separation distance 214 between the print head 204 and the circuit board 100. Accordingly, the inkjet printer 200 may further comprise a vertical adjustment mechanism. As illustrated in FIG. 2, in one embodiment the vertical adjustment mechanism 216 may be configured to adjust a vertical position of the head assembly 202, and therefore the vertical position print head 204 along a vertical axis Z. For example, the vertical adjustment mechanism 216 may employ a displaceable piston 218 to adjust the vertical position of the head assembly 202. However, as noted above, various embodiments of components and assemblies may be employed to move the head assembly 202. Thus, the vertical adjustment mechanism 216 is not illustrated in the remaining figures.

Thus, returning to FIG. 4, the position of the print head 204 along the vertical axis Z may be adjusted such that the separation distance 214 between the print head and the circuit board 100 remains substantially constant as the horizontal position of the print head changes during printing. Thus the substantially constant separation distance 214 between the print head 204 and the circuit board 100 may allow the inkjet printer 200 to deposit a substantially uniform layer of the conductive ink on both the first surface 102A of the component 102 and the first surface 104A of the substrate 104.

However, as noted above, the circuit board 100 (or other object being printed on) may be a three-dimensional object. In this regard, when the circuit board 100 is positioned such that the first surface 102A of the component 102 and the first surface 104A of the substrate 104 are oriented horizontally, as illustrated in FIGS. 3 and 4, various other surfaces of the circuit board may not be upwardly oriented. For example, the circuit board 100 may define non-parallel surfaces. In the illustrated embodiment the component 102 of the circuit board 100 comprises a plurality of side surfaces 102B-G. Since the side surfaces 102B-G are perpendicular to the first surface 102A of the component 102 and the first surface 104A of the substrate 104, they are not upwardly oriented when the first surfaces are oriented horizontally.

Notably, the print head 204 may eject conductive ink substantially downwardly along the vertical axis Z. In this regard, the ink may be ejected from the print head 204 under a relatively small amount of pressure such that the droplets of ink are substantially directed downwardly, regardless of an angle at which the print head is positioned relative to the vertical axis Z. Thus, it may be difficult for the inkjet printer 200 to print on surfaces of the circuit board 100 that are vertically or downwardly oriented (e.g., undercut).

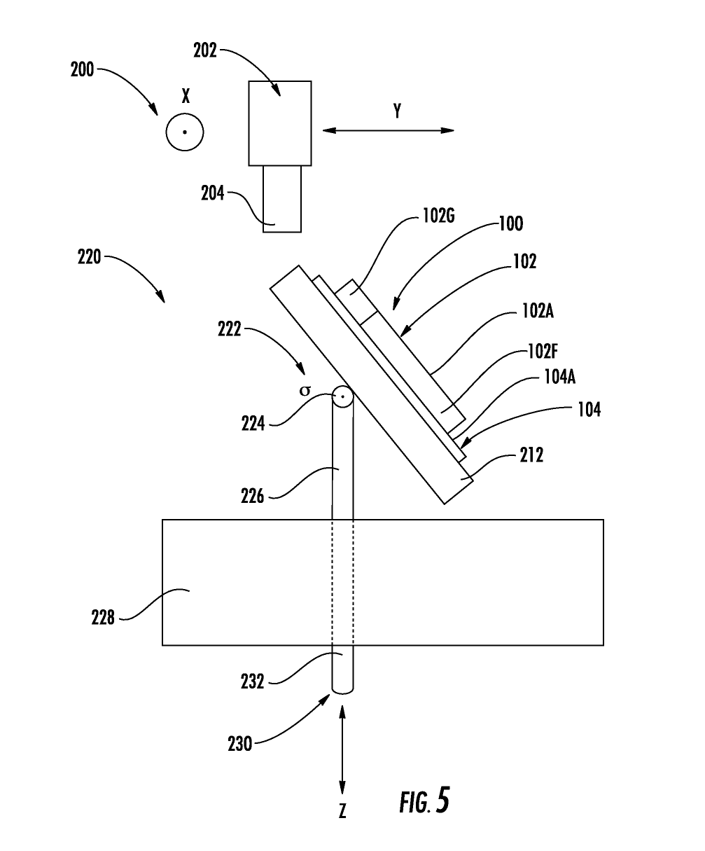

Accordingly, the inkjet printer 200 may include features configured to facilitate printing on objects that include non-parallel surfaces. In this regard, as illustrated in FIG. 5, the inkjet printer 200 may include an assembly 220 configured for adjusting a position of a three-dimensional object (e.g., the circuit board 100) in the inkjet printer. The adjustment assembly 220 may include the above-noted fixture 212, which holds the circuit board 100. Further, the adjustment assembly 220 may include a tilt adjustment mechanism 222. The tilt adjustment mechanism 222 may be coupled to the fixture 212 and configured to adjust a tilt angle σ of the circuit board 100 about a horizontal axis.

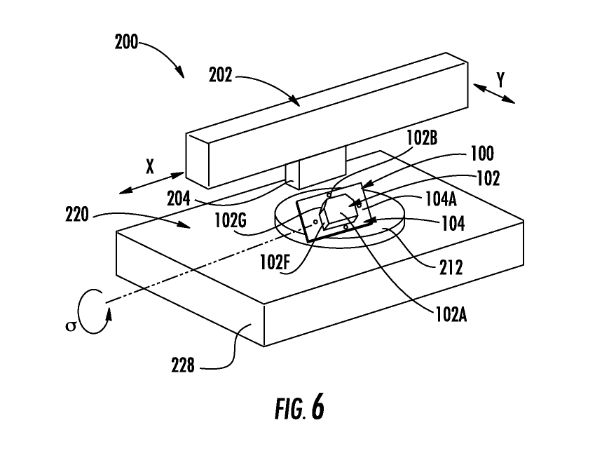

Accordingly, the tilt angle σ may be adjusted such that other surfaces of the circuit board 100 may be upwardly oriented and hence positioned such that the print head 204 may print thereon. For example, as illustrated in FIG. 6, a first side surface 102B may be upwardly oriented by adjusting the tilt angle σ of the circuit board 100 such that the print head 204 may print thereon. The tilt angle σ to which the tilt adjustment mechanism 222 is configured to tilt the circuit board 100 may vary. In one embodiment the tilt adjustment mechanism 222 may be configured to tilt the circuit board 100 such that the exposed surfaces 102A-G, 104A of the circuit board 100 define a tilt angle σ of at least about 45 degrees relative to vertical. Accordingly, by tilting the circuit board 100 in this manner, the tilt adjustment mechanism 222 may upwardly orient additional surfaces (e.g., surfaces 102B, 102E of the component 102 in the configuration illustrated in FIGS. 5 and 6) such that the print head 204 may eject ink thereon. However, in other embodiments the tilt adjustment mechanism 222 may be configured to tilt the circuit board 100 to larger tilt angles. For example, the tilt adjustment mechanism 222 may be configured to tilt each of the surfaces of the circuit board 100 to be printed on such that they define a tilt angle σ of at least about 90 degrees relative to vertical (i.e., such that the surfaces are horizontal) in one embodiment.

As illustrated in FIG. 5, in one embodiment the tilt adjustment mechanism 222 may comprise a hinge 224 about which the fixture 212 pivots to adjust the tilt angle σ. The hinge 224 may be coupled to a shaft 226 that separates the fixture 212 from a base member 228. Accordingly, as the fixture 212 pivots about the hinge 224, the fixture may avoid contact with the base member 228.

In some embodiments the adjustment assembly 220 may comprise a vertical adjustment mechanism 230 (see, e.g., FIG. 5) configured to adjust the separation distance 214 (see, e.g., FIG. 4) between the print head 204 and the circuit board 100. For example, a displaceable piston 232 may be coupled to, or integral with, the shaft 226 such that the vertical position of the fixture 212 and the circuit board 100 may be adjusted. The vertical adjustment mechanism 230 of the adjustment assembly 220 may be provided in addition to, or instead of the vertical adjustment mechanism 216 configured to adjust the vertical position of the head assembly 202. Thus, the separation distance 214 (see, e.g., FIG. 4) between the print head 204 and the circuit board 100 may be adjusted by one or both of the vertical adjustment mechanisms 216, 230. However, since the vertical adjustment mechanism 230 may or may not be included in the adjustment assembly 220, and since various embodiments of components may be employed to adjust the vertical position of the circuit board 100, the vertical adjustment mechanism of the adjustment assembly 220 is not illustrated in the remaining figures.

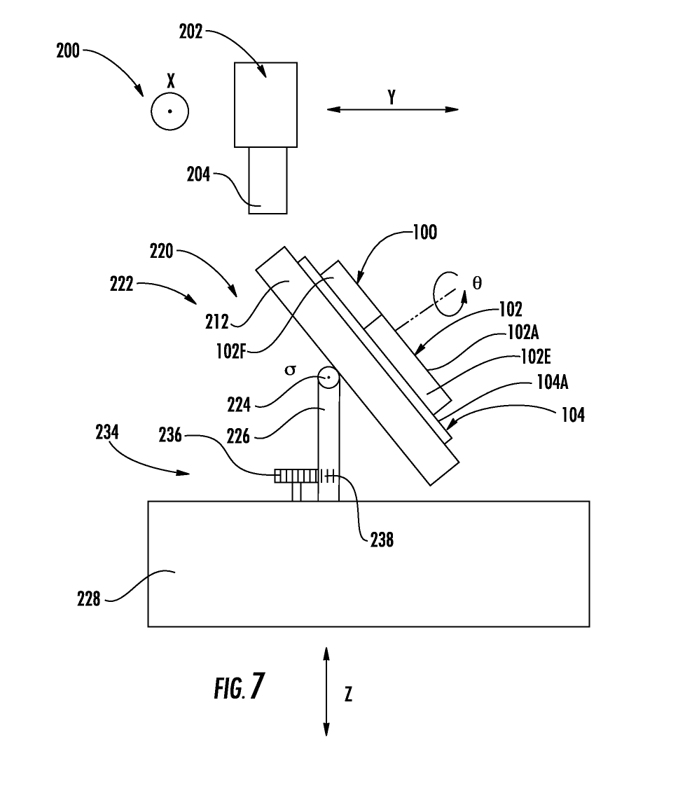

As illustrated in FIG. 7, in some embodiments the adjustment assembly 220 may further comprise a rotational adjustment mechanism 234 coupled to the fixture 212 and configured to adjust an angular position θ of the fixture 212 and the circuit board 100 about a vertical axis Z. By way of example, the shaft 226 may be a rotatable shaft. In the embodiment illustrated in FIG. 7, the rotational adjustment mechanism includes a gear 236 that engages corresponding teeth 238 on the shaft 226. Accordingly, by rotating the gear 236, the shaft 226 may also rotate in order to adjust the angular position θ of the fixture 212 and the circuit board 100. However, various other components may be employed to adjust an angular position θ of the fixture 212 and the circuit board 100. Accordingly, the angular adjustment mechanism 234 is not illustrated in the remaining figures.

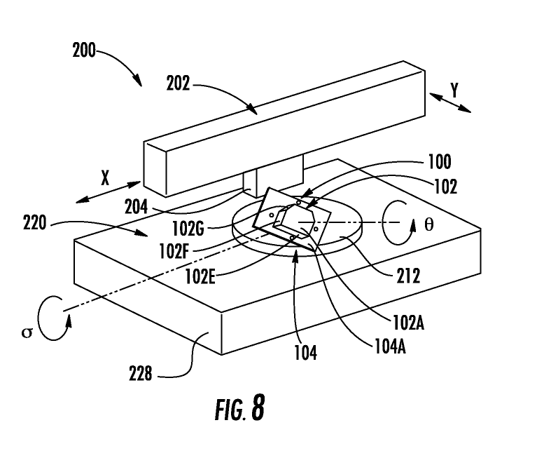

By adjusting the angular position θ of the circuit board 100, the remaining side surfaces 102C, D, F, G of the component may be printed on. For example, FIG. 8 illustrates the inkjet printer 200 in a configuration in which the angular position θ of the fixture 212 and the circuit board 100 has been adjusted such that an additional side surface 102G is oriented upwardly and configured to be printed on by the print head 204. Thereafter, the angular position θ of the fixture 212 and the circuit board 100 may be adjusted such that any remaining side surfaces 102C, D, F of the component 102 and/or substrate 104 may also be printed on.

Accordingly, as described above, the fixture 212 may hold the circuit board 100 (or other object) such that multiple surfaces thereof (e.g., nonparallel surfaces) are exposed. As further described above, the tilt adjustment mechanism 222 and the rotational adjustment mechanism 234 may be configured to upwardly orient the various exposed surfaces of the circuit board 100. Thereby, the print head 204 may print on each of the exposed surfaces. Thus, embodiments of the inkjet printer 200 including the adjustment assembly 220 may function to print on surfaces of the circuit board 100, regardless of whether or not the surfaces are parallel to one another and regardless of their initial orientation in the fixture 212. Accordingly, by way of example, conductive ink may be printed onto the exposed surfaces 102A-G of the component, the first surface 104A of the substrate 104, and the grounding pads 106 such that an EMI shield is produced.

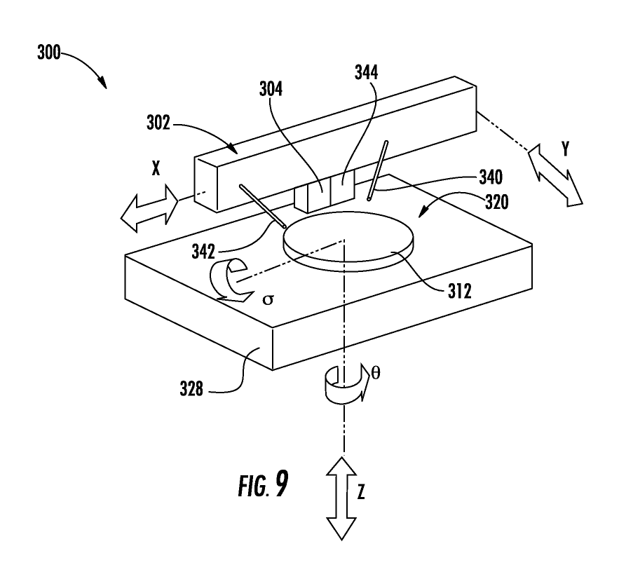

FIG. 9 illustrates an alternate embodiment of an inkjet printer 300. The inkjet printer 300 illustrated in FIG. 9 may include some or all of the components of the previously described embodiment of an inkjet printer 200, which are referenced by similar reference numerals. In this regard, the inkjet printer 300 may include a head assembly 302 comprising a print head 304 and an adjustment assembly 320. However, the inkjet printer 300 illustrated in FIG. 9 may include one or more additional components configured to provide additional functionality.

For example, the inkjet printer 300 may additionally include an insulation remover 340. In one embodiment the insulation remover 340 may comprise a laser. Thus, the laser may be employed to burn off dielectric insulation material at grounding pads or other areas on an object where it may be desirable to directly print ink thereon.

The inkjet printer 300 may also include a pretreatment apparatus 342 configured to direct a pretreatment onto the object being printed on. For example, the pretreatment apparatus 342 may be configured to produce ozone using ultraviolet light, or produce argon plasma, either of which may be emitted onto the object through a wand or other conduit. By directing a pretreatment onto the object with the pretreatment apparatus 342, the conductive ink may more easily adhere to the object. In this regard, the dielectric insulating material previously applied to the object may tend to be hydrophobic, and the conductive ink may be viscous. Notably, pretreatments may remain effective for a relatively short period of time. Thus, by coupling the pretreatment apparatus 342 to the print head 304 either directly, or through the head assembly 302, the pretreatment apparatus may pretreat each surface of an object immediately prior to printing ink thereon, such that issues with respect to the time period during which the pretreatment is effective may be avoided.

The inkjet printer 300 may further comprise a curing apparatus 344, which may be coupled to the print head 304 either directly, or through the head assembly 302. The curing apparatus 344 may be configured to emit heat and/or light in order to cure the conductive ink. For example, the conductive ink may comprise metal particles surrounded by plastic. The curing apparatus 344 may burn off the plastic and melt the metal particles such that a continuous metal layer is formed. Accordingly, the curing apparatus 344 may cure the ink. Due to placement in the inkjet printer 300, the curing apparatus 344 may substantially immediately cure the ink after printing on an object such that issues with respect to the ink moving from the position where it is originally placed by the print head 304 may be mitigated or avoided.

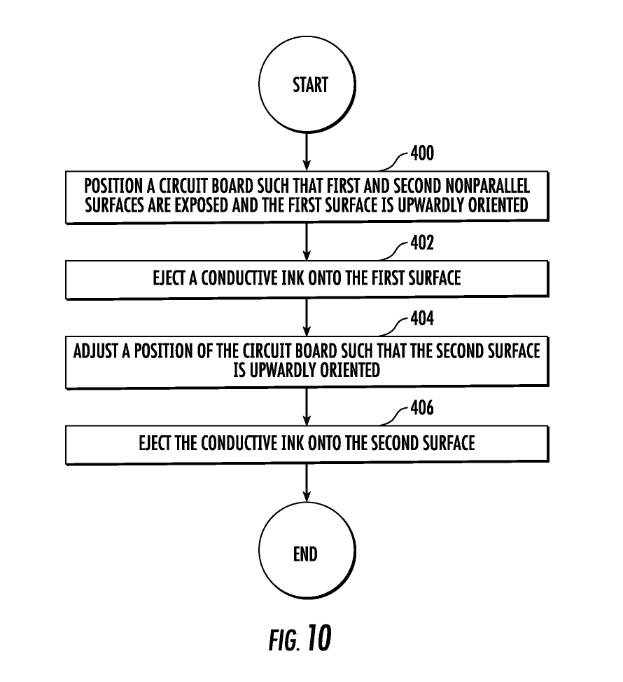

A related method for printing on a three-dimensional object is also provided. As illustrated in FIG. 10, the method may include positioning a circuit board proximate a print head such that a first surface and a second surface that are nonparallel are exposed and the first surface is upwardly oriented at operation 400. The method may also include ejecting a conductive ink onto the first surface of the circuit board at operation 402. The method may further comprise directing a pretreatment onto the first surface prior to ejecting the conductive ink onto the first surface at operation 402.

Further, the method may include adjusting a position of the circuit board such that the second surface is upwardly oriented at operation 404. Adjusting the position of the circuit board at operation 404 may comprise adjusting a tilt angle of the circuit board and/or adjusting an angular position of the circuit board. Also, the method may include ejecting the conductive ink onto the second surface of the circuit board at operation 406. The method may additionally include directing the pretreatment onto the second surface prior to ejecting the conductive ink onto the second surface at operation 404. The method may further comprise curing the conductive ink.

Note that the present disclosure has generally been described in terms of applicability in forming EMI shields for example purposes only. In this regard, the apparatuses and methods disclosed herein may be configured for inkjet printing on a variety of objects, including objects other than circuit boards. Further, the ink printed in accordance with the present disclosure need not be conductive ink in all embodiments. Further, the adjustment mechanisms disclosed herein are provided for example purposes only. In this regard, various other structures and mechanism may be configured to adjust the position of an object being printed on.

Although the foregoing disclosure has been described in detail by way of illustration and example for purposes of clarity and understanding, it will be recognized that the above described disclosure may be embodied in numerous other specific variations and embodiments without departing from the spirit or essential characteristics of the disclosure. Certain changes and modifications may be practiced, and it is understood that the disclosure is not to be limited by the foregoing details, but rather is to be defined by the scope of the appended claims.

What is claimed is:

1. An assembly configured for adjusting a position of a three-dimensional object in an inkjet printer, the assembly comprising:
a fixture configured to hold a circuit board such that first and second nonparallel surfaces of the circuit board are exposed;
a tilt adjustment mechanism coupled to the fixture and configured to adjust a tilt angle of the circuit board; and
a rotational adjustment mechanism coupled to the fixture and configured to adjust an angular position of the circuit board,
wherein the tilt adjustment mechanism and the rotational adjustment mechanism are configured to upwardly orient the first and second nonparallel surfaces of the circuit board.

2. The assembly of claim 1, further comprising a vertical adjustment mechanism coupled to the fixture and configured to adjust a vertical position of the circuit board.

3. The assembly of claim 1, wherein the tilt adjustment mechanism is configured to tilt the first and second nonparallel surfaces of the circuit board to the tilt angle at least about 45 degrees from vertical.

4. The assembly of claim 1, wherein the rotational adjustment mechanism comprises a rotatable shaft.

5. The assembly of claim 4, wherein the tilt adjustment mechanism comprises a hinge coupled to the rotatable shaft.

6. An inkjet printer configured for printing on a three-dimensional object, comprising:
a print head configured to eject an ink; and
an assembly configured for adjusting a position of a circuit board relative to the print head, the assembly comprising:
a fixture configured to hold the circuit board such that first and second nonparallel surfaces of the circuit board are exposed;
a tilt adjustment mechanism coupled to the fixture and configured to adjust a tilt angle of the circuit board; and
a rotational adjustment mechanism coupled to the fixture and configured to adjust an angular position of the circuit board,
wherein the tilt adjustment mechanism and the rotational adjustment mechanism are configured to upwardly orient the first and second nonparallel surfaces of the circuit board.

7. The inkjet printer of claim 6, further comprising a vertical adjustment mechanism configured to adjust a separation distance between the print head and the circuit board.

8. The inkjet printer of claim 7, wherein the vertical adjustment mechanism is configured to adjust a vertical position of the circuit board.

9. The inkjet printer of claim 7, wherein the vertical adjustment mechanism is configured to adjust a vertical position of the print head.

10. The inkjet printer of claim 6, further comprising a horizontal adjustment mechanism configured to adjust a horizontal position of the print head.

11. The inkjet printer of claim 10, wherein the horizontal adjustment mechanism is configured to adjust the horizontal position of the print head along first and second axes.

12. The inkjet printer of claim 6, wherein the tilt adjustment mechanism is configured to tilt the first and second nonparallel surfaces of the circuit board to the tilt angle of at least about 45 degrees from vertical.

13. The inkjet printer of claim 6, further comprising a pretreatment apparatus configured to direct a pretreatment onto the circuit board.

14. The inkjet printer of claim 13, wherein the pretreatment apparatus is coupled to the print head.

15. The inkjet printer of claim 6, further comprising a curing apparatus configured to cure the ink.

16. The inkjet printer of claim 15, wherein the curing apparatus is coupled to the print head.

17. The inkjet printer of claim 6, further comprising an insulation remover.

18. A method for inkjet printing on a three-dimensional object, comprising:
positioning a circuit board proximate a print head such that a first surface and a second surface that are nonparallel are exposed and the first surface is upwardly oriented;
ejecting a conductive ink onto the first surface of the circuit board;
adjusting a position of the circuit board such that the second surface is upwardly oriented; and
ejecting the conductive ink onto the second surface of the circuit board.

19. The method of claim 18, wherein adjusting the position of the circuit board comprises adjusting a tilt angle of the circuit board.

20. The method of claim 18, wherein adjusting the position of the circuit board comprises adjusting an angular position of the circuit board.

21. The method of claim 18, further comprising directing a pretreatment onto the first surface prior to ejecting the conductive ink onto the first surface; and
directing the pretreatment onto the second surface prior to ejecting the conductive ink onto the second surface.

22. The method of claim 18, further comprising curing the conductive ink.
